(19) United States
(12) Patent Application Publication
(10) Pub. No.: US 2009/0080997 A1
(43) Pub. Date: Mar. 26, 2009

(54) Retaining Device and Apparatus

(76) Inventor: Jeffrey Johnson, WestMidlands (GB)

Correspondence Address: Beusse Wolter Sanks Mora & Maire, 390 N. ORANGE AVENUE, SUITE 2500, ORLANDO, FL, 32801, US

(21) Appl. No.: 11/862,422

(22) Filed: Sep. 27, 2007

(30) Foreign Application Priority Data
Sep. 24, 2007 (GB) 0718580,4

(51) Int. Cl. F16B 21/10

(52) U.S. Cl. 411/347

(57) ABSTRACT

The present invention provides a retaining device and apparatus (10) comprising a retaining means (14) having a retaining ring (32) provided in circumferentially extending groove (30) located on a shank portion of a screw at a location remote from said head portion (26) which, in operation acts to retain said screw in a hole into which it has been inserted. The size of the hole and the size of the ring being matched to allow insertion by contraction of the ring and retention thereof once positioned whilst also allowing removal without undue force.

The present invention relates to a retaining device and relates particularly but not exclusively to a retaining device in combination with a mounting member to be mounted as an implant or prosthetic device in a human or animal body.

It is known to mount or secure implants or prosthetic devices by using screws or expanding fixation devices which generally comprise a head portion and a shank that is either provided with a screw thread for screwing into adjacent bone material or an expanding portion which expands so as to create an interference fit within an already drilled hole within the adjacent bone structure. An example of the former arrangement is shown in U.S. Pat. No. 5,364,399 which discloses a retaining device in the form of a screw having a shank having a circumferentially extending groove provided therein which is sized such as to accommodate an O-ring of deformable material. When the screw and ring are in position the O-ring acts to engage with both the groove and the surface adjacent a hole through which the screw has been inserted such as to provide a degree of resistance to inadvertent or undesired removal of the screw itself. The O-ring is described as being of an elastomeric material and it is thought that the ring is squashed as the screw is inserted into an associated hole such that it may slide along the inner surface of the hole and return to its otherwise un-deformed shape upon emerging from the other side of the hole. Such an arrangement is thought to be able to provide a relatively limited degree of resistance to the removal of the screw from the hole into which it is inserted. Still further, such an arrangement can only ever provide the same degree of resistance to removal as it offers to insertion.

An alternative securing arrangement is shown in U.S. Pat. No. 6,579,290 which provides an expandable retaining device best seen in FIG. 15 and which employs a central expansion element which, in operation, is driven into an already positioned split retaining device such as to cause portions thereof to expand and engage with bone material immediately surrounding a hole in which the device is inserted. Whilst this device provides a good degree of screw retention it is dependent upon the process of driving engaging portions of the screw into adjacent bone material which may cause damage thereto during both insertion and removal. Indeed, removal can be slightly problematic as the expanded portions must first be disengaged from the surrounding bone material before the device can be unscrewed.

It is an object of the present invention to provide a retaining device and apparatus retained thereby which provides a secure location of the fixation device itself whilst also allowing for the removal thereof as and when required.

Accordingly, the present invention provides retaining device, comprising a screw and a ring, said screw having a thread portion, a head portion and a shank portion of diameter D, said shank portion including a circumferentially extending groove in an outer diameter thereof for receiving said retaining ring, wherein said groove is spaced from said head portion and said ring comprising a split spring ring having a first compressed diameter (D_{c}) and a second expanded diameter (Dₑ) and wherein, in an expanded state, said ring includes a retaining portion for retention in said groove and a projecting portion for projecting beyond said groove and shank diameter D and for retaining said screw relative to an adjacent member.

It will be appreciated that by providing the ring in the form of a split ring rather than an O-ring and by sizing the groove to accommodate the ring during insertion of the device into an associated aperture, one may provide an arrangement that has a secure fixation whilst also being relatively easy to insert and remove.

Preferably, said ring has a radial depth Dᵣ and said groove has a depth D_{g} within which at least a portion of the ring may be accommodated when said ring is at its compressed diameter (D_{c}).

Advantageously, the retaining device includes a mounting member having a corresponding mounting aperture through which, in operation, said retaining device may be inserted, said mounting hole having a diameter Dₕ larger than said shank diameter D but less than the expanded diameter Dₑ of said ring and having a length L equal to or less than the distance between the head and the groove portion. The mounting member may include a complete circumferentially extending groove on an outer back surface for receiving said ring when said ring is in said expanded state. Advantageously, said groove includes a tapered portion adjacent an inlet or outlet from said aperture for assisting with the easy insertion and extraction of the ring.

The device itself may comprise an implant or a prosthesis for use in the human or animal body and may include a mounting plate which may form a vertebral cage or vertebral plate.

Preferably, said mounting device includes a head receiving portion for receiving a head of a screw and further includes a tapered portion towards a base of said receiving portion for guiding said retaining ring as it is inserted.

Advantageously, said mounting device includes an exit portion into which the retaining device exits upon insertion and in which said exit portion includes a tapered portion tapering inwardly towards the base thereof so as to assist with the compression of the ring upon removal.

The ring itself may comprise a round ring or may comprise a generally square cross-sectional ring and may include a tapered portion on outer leading or trailing edge.

The present invention also provides a method of securing a mounting member having a hole of diameter Dₕ, said method including the step of selecting a retaining device as claimed in any one of claims 1 to 12 wherein said shank diameter D is less than the hole diameter Dₕ, said ring expanded diameter Dₑ is greater than said hole diameter Dₕ, and said ring compressed diameter D_{c} is less than the diameter Dₕ of said hole, said method including the steps of inserting said mounting member into said hole, causing said ring to be compressed to said compressed diameter D_{c} passing said shank and ring through said hole and allowing said ring to expand to said expanded diameter Dₑ on an outlet side of said hole such as to cause said ring to resist said retaining device from being withdrawn back through said hole.

The present invention will now be more particularly described by way of example only with reference to the accompanying drawings, in which:

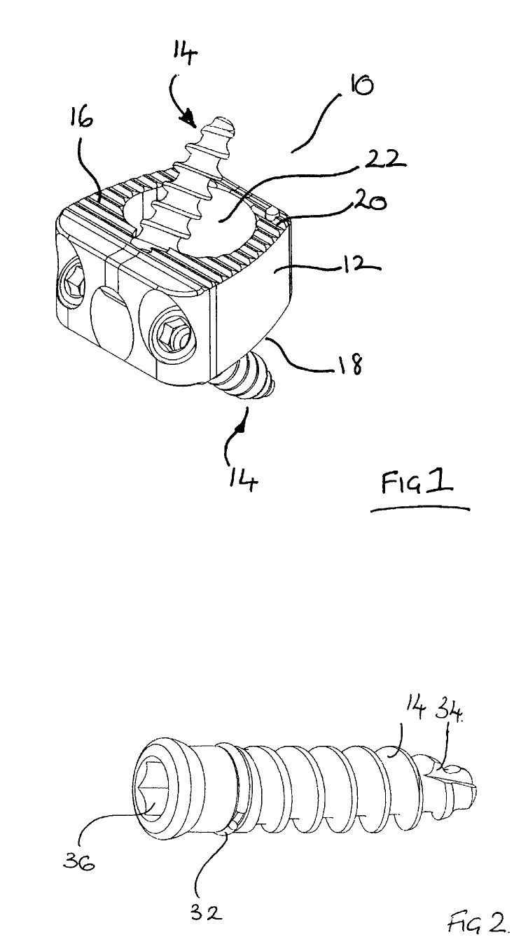

FIG. 1 is a general view of a cervical plate and screw arrangement where the plate forms a mounting member as discussed later herein;

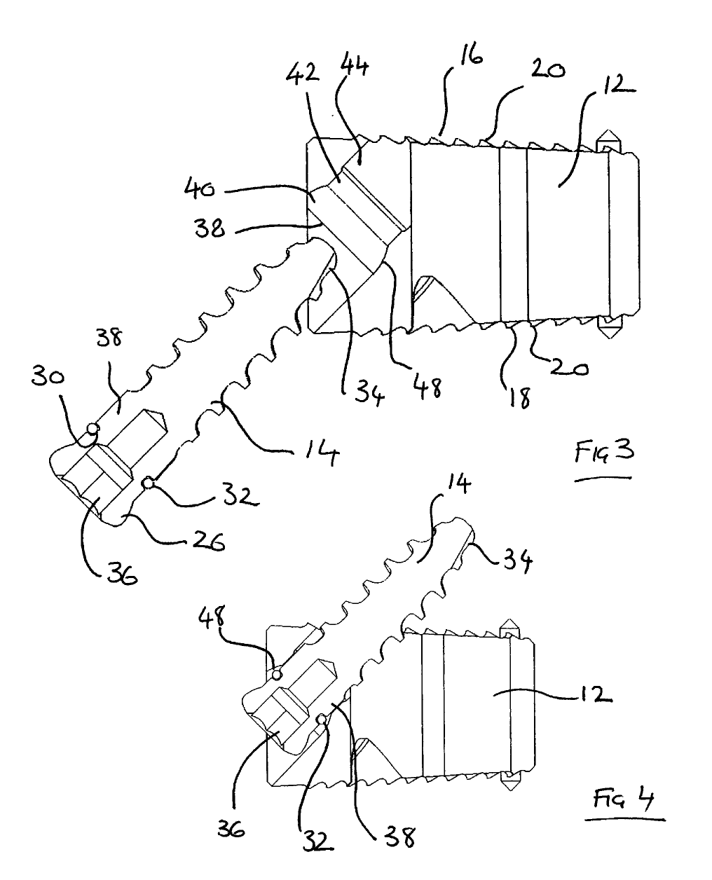

FIG. 2 is a detailed view of the screw and ring assembly of FIG. 1;

FIGS. 3 to 5 are cross-sectional drawings of FIG. 1 and illustrate the screw insertion steps;

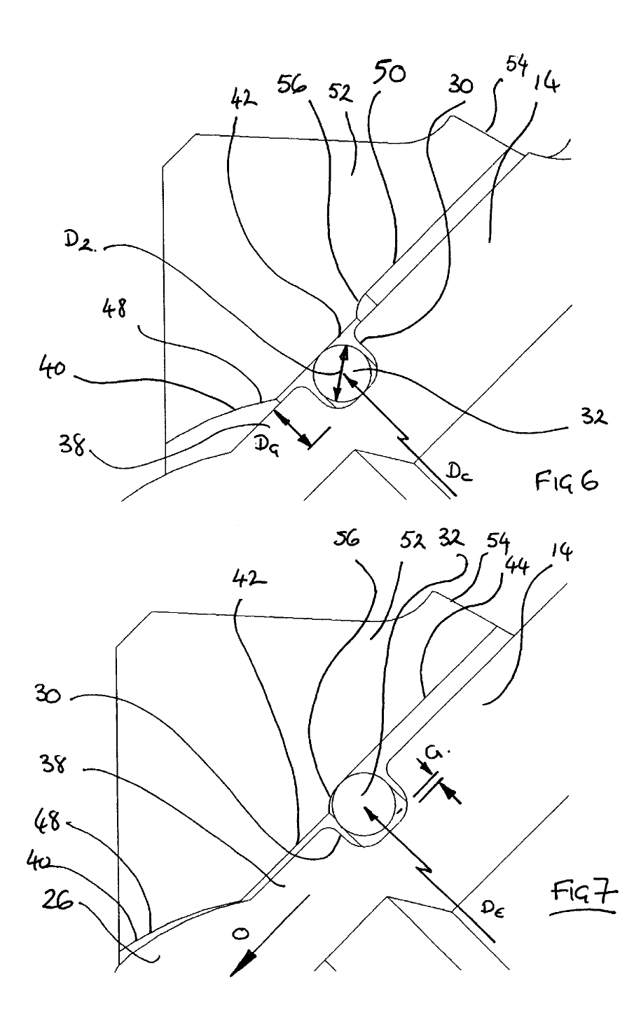

FIGS. 6 and 7 are detailed cross-sectional views showing the retaining ring as it passes through the associated hole and after it is locked in its retaining position;

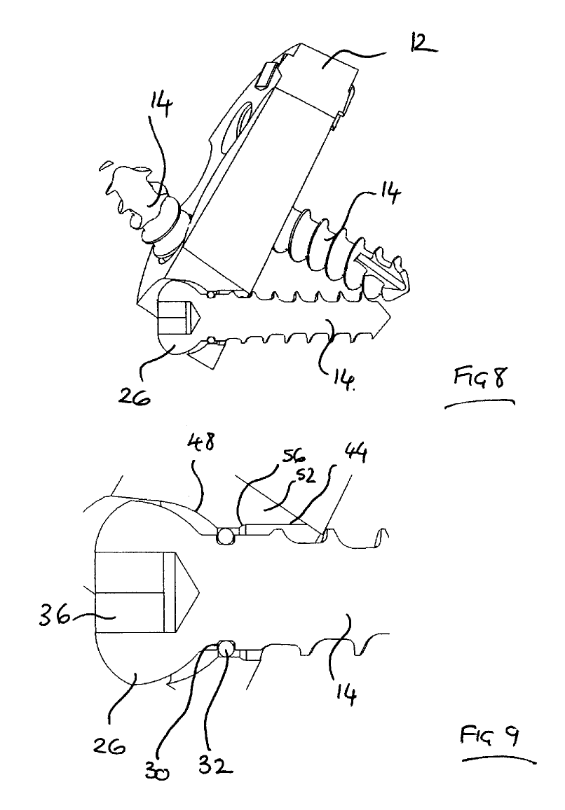

FIG. 8 illustrates an alternative form of mounting member in the form of a cervical, thoracic or lumbar plate;

FIG. 9 is a detailed cross-sectional view of the lower portion of FIG. 8;

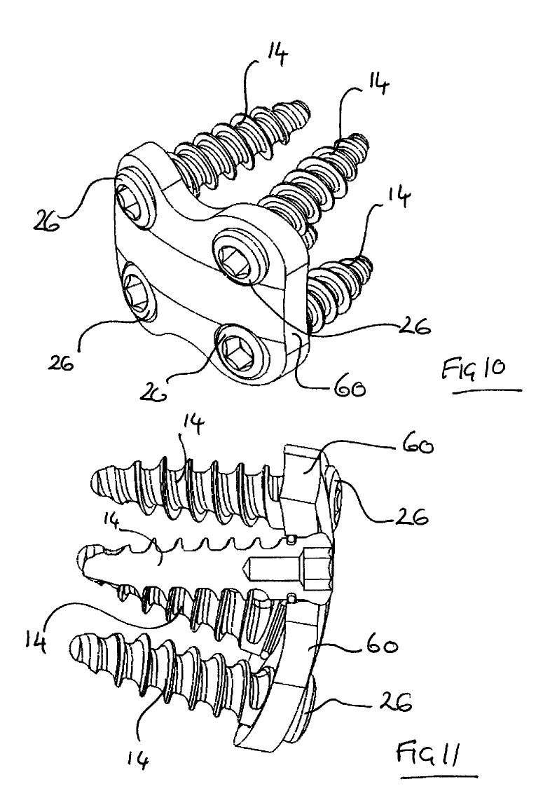

FIG. 10 is a general view of a cage plate for use in securing two vertebral bodies together;

FIG. 11 is a partial cross-sectional view of the cage plate shown in FIG. 10;

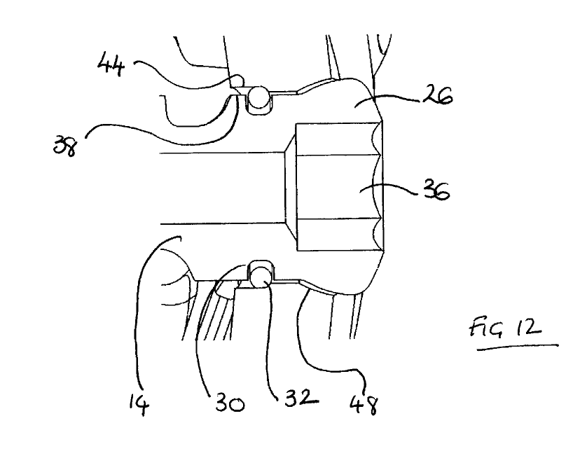

FIG. 12 is a detailed cross-sectional view of the retaining features of FIGS. 9 and 10;

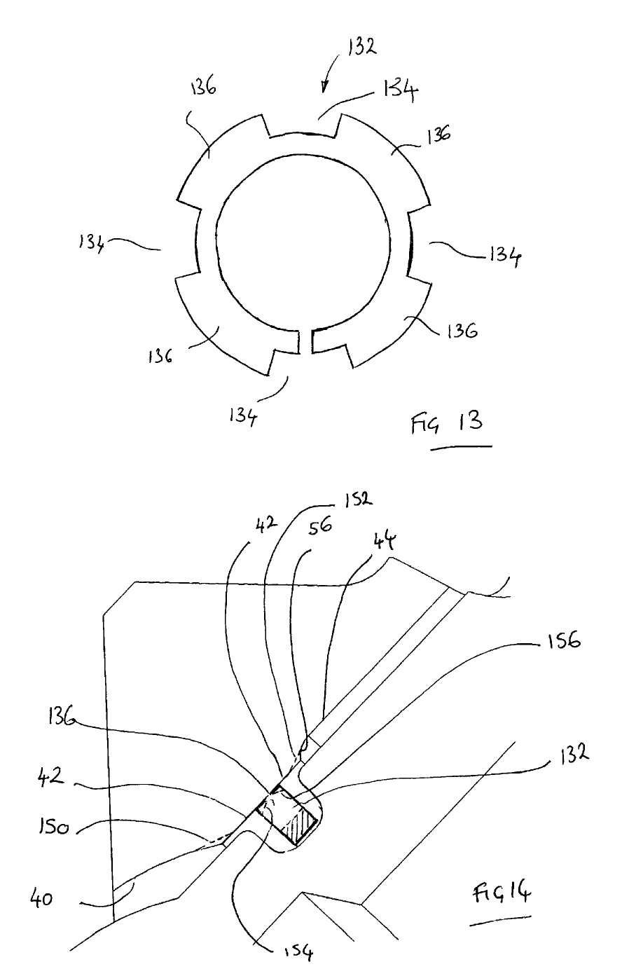

FIG. 13 is a view of an alternative form of spring ring; and

FIG. 14 is a cross-sectional view of the alternative ring of FIG. 13 within a portion of the device itself.

Referring now to the drawings in general but particularly to FIGS. 1 to 5, it will be seen that a device shown generally at 10 comprises a mounting member such as, for example, a cervical implant 12 and a screw assembly 14 for retaining said device in a desired position once inserted into the body. Such implants generally include upper and lower surfaces 16, 18 for contacting cervical portions (not shown) and may include location or securing features shown as ridges 20 in each of the drawings. As shown, the screws 14 are directed either upwardly into an upper cervical body or downwardly onto a lower body (nor shown) and may be directed through a portion of the upper and lower surfaces 16, 18 or may be directed into an inner void region 22 and angled such as to emerge therefrom at a position suitable for allowing the screw 14 to be secured to the appropriate vertebral body.

FIG. 2 illustrates in more detail the screw arrangement 14, from which it will be appreciated that the screw comprises a threaded portion 24, a head portion 26 and a shank portion 28 having a circumferentially extending groove 30 provided within said shank portion at a position remote from the head portion 26, for reasons that will become apparent later and for receiving a retaining ring in the form of a split ring 32 formed of sprung material. The screw may also include a self drilling tip portion 34 and a hexagonal recess 36 within the head into which an Allen key or the like may be inserted for tightening said screw.

FIG. 3 illustrates in more detail the shape of a hole or aperture 38 in the plate through which the screw 14 is to be inserted. In detail, the aperture comprises three main portions, namely a head locating portion 40, a minimum diameter portion 42 and an exit portion 44 which will be described in detail later hereon. The sizing of the latter two portions is important as the security of the screw within the aperture is contingent upon suitable sizing thereof relative to the screw 14 and the retaining ring 32. The shank portion has a diameter D1 and the split ring 32 has a first compressed diameter Dc and a second uncompressed or expanded diameter De. The ring 32 has a radial depth Dr and the groove 30 has a depth Dg which is such as to allow the ring to be at least partially, and preferably mostly, accommodated within said groove when in its compressed state. Said ring 32 has a radial depth and diameter D2 such as to allow an inner portion thereof to remain engaged within the groove even when in its fully expanded state whilst an outer diameter thereof will extend beyond said groove 30 such as to engage with an adjacent structure, when present. Later figures illustrate this arrangement in more detail.

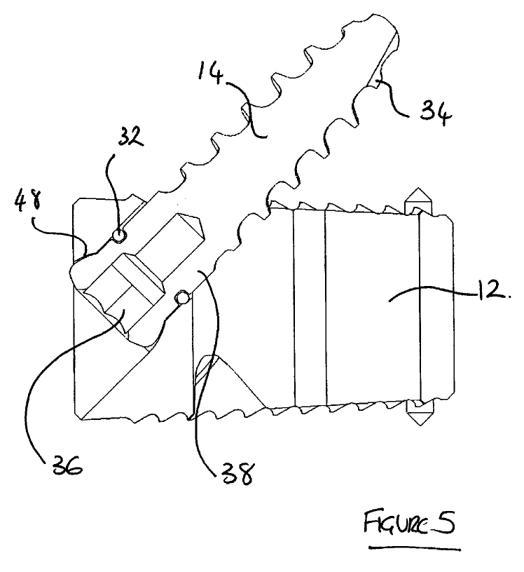

FIG. 4 illustrates a screw 14 having been inserted into the aperture to a depth that allows the ring 32 to be compressed by the interaction thereof with suitably tapered edges 48 provided in the head retaining portion 40 and then guided into the reduced diameter section 42 where an outer diameter of said ring engages with said hole. The fact that the ring is a split ring of spring material and the groove has a sufficient depth to accommodate it when in its compressed state allows it to be maintained in the compressed state as it is slid through the hole and prevents any major force being exerted by the ring that might otherwise make insertion of the screw problematic.

The installed state of the screw is shown in FIG. 5, from which it will be appreciated that the spring ring 32 has emerged from the reduced diameter portion 42 and has now returned to its expanded diameter such as to allow an outer portion thereof to engage with the adjacent material through which the aperture projects. Whilst this arrangement is best seen with reference to FIG. 6, it will be appreciated that in order for the spring ring 32 to be able to expand to its full diameter state one need provide a circumferentially extending groove on an outer back surface of the mounting member such as to allow the ring freedom to expand thereinto.

FIGS. 6 and 7 illustrate the interaction of the ring 32 and the surrounding material in more detail and from these drawings the reader will appreciate that the groove depth Dg is such as to allow the spring ring to be at least partially accommodated therein when in its compressed state, as seen in FIG. 6. Indeed, the arrangement is preferably such that a significant portion of the ring 32 is accommodated within said groove when said ring is in the compressed state, that way there will be more ring surface available for engagement with corresponding portions of the groove and surrounding material when said ring 32 is in its expanded state. From FIG. 6, it will be appreciated that the ring 32 has a compressed diameter Dc which is less than the diameter Da of any aperture through which it is to be inserted, thereby to allow the ring 32 to be compressed to a suitable diameter for passage through said aperture. The diameter of the shank portion D is just slightly less than the aperture diameter Da such as to allow for its easy passage through said aperture. FIG. 7 illustrates the secured position in which the ring 32 has expanded into a circumferentially extending groove 50 on an outer back portion of any material 52 surrounding the aperture. Preferably, the groove 50 comprises a complete circumferential groove such that the ring 32 is free to expand into it without a portion of the ring extending beyond the surface 54 of the material. Such an arrangement would allow the ring to expand and retain the screw 14 without interference from any adjacent bone material that might be immediately adjacent the back face 52 itself and thus allows for better location and securing of any device than some prior art arrangements in which such a clearance is not provided and the ring is prevented from performing its function correctly and may compromise the secure location of the mounted member 12. Also of note in FIG. 7 is a tapered portion 56 provided at the outlet to the aperture and which, in use, allows for the extraction of the screw against the action of the retaining ring 32 as and when required. In operation, a screw may be removed by simply reversing the rotation of insertion such that it moves outwardly in the direction of arrow O and causes the ring 32 to engage with the slope or tapered portion 56. Upon engagement with the tapered portion 56 the ring 32 will be forced radially inwardly such as to cause said ring to contract to an inner, contracted, diameter Dc at which it may once again pass along the restricted diameter portion 42 and may be removed from the aperture all together. The amount of force required to remove the screw is considerably more than might be exerted on said screw in normal operation or use of said screw as a retaining screw but is less than can be easily exerted on said screw by a surgeon using an extraction tool or the like which may engage with hexagonal head portion 36 and which may be power driven.

From the above, it will be appreciated that the present invention provides a simple yet robust method of retaining a screw in an aperture which at least reduces the chances of accidental or undesirable removal thereof whilst in use. Additionally, it will be appreciated that if one does not wish to remove the screw at a later time one can simply eliminate the tapered portion 56 such as to eliminate any assistance that it would otherwise give during the removal process.

Other arrangements of the present invention are illustrated in the remaining drawings in which FIG. 8 is an alternative view of another spinal implant and illustrates the angular juxtaposition of the screws 14 relative to each other and the implant 12. FIG. 9 illustrates in detail the interaction of the ring 32 of FIG. 8 as the screw 14 of this figure is inserted. All design features of the screw 14, ring 32 and aperture 38 remain as described above and all variations thereof may be incorporated into the arrangement of these drawings.

FIGS. 10 to 12 illustrate a still further arrangement of the present invention in which the screw arrangement 14 is provided in a cervical plate arrangement shown generally at 60. Such arrangements are employed when it is desired to immobilise one vertebral body relative to another and may further include a cervical plate similar to that shown and discussed otherwise herein. From FIGS. 11 and 12 it will be appreciated that the design of the retaining ring 32 and aperture 38 is as above and may include any variations discussed herein. Of particular note in FIG. 12 is the fact that when the ring 32 is deployed in its activated state it is still well clear of the inner surface 54 and, hence, is able to be deployed without hindrance and is well clear of any adjacent bone material such as to allow the plate itself to lie flush against the surface of the bone and facilitate a more secure mounting than might otherwise be possible in some of the prior art arrangements.

An alternative form of the ring is shown at 132 in FIG. 13, from which it will be appreciated that the ring comprises a plurality of cut-out portions 134 which, effectively, thin the ring at one or more circumferentially spaced locations. The outstanding portions of material or “tabs” 136 engage with the component within which the screw is to be placed whilst the inner portion remains within the groove 30 of the screw itself. The thinned sections effectively create a more flexible ring than might be possible had the cut-out portions not been provided whilst the tabs engage in the manner described above whilst still providing adequate resistance to extraction.

FIG. 14 illustrates the arrangement of FIG. 13 in operation, from which it will be appreciated that the tabs 136 engage with the surrounding material as described above with referenced to FIGS. 5 and 6 whilst the inner portion of the engages with the cut-out 30 in the usual manner. Additional in FIG. 14 is the provision of optional tapered surfaces at 150, 152, 154 and 156. Surface 150 assists with the easing of the ring into the device whilst taper 152 assists with the easing of the ring out of the device. The steepness of these tapers may be altered according to the desired degree of retention/ease of insertion. If necessary or desirable, additional tapered portions 154 and 156 may be provided on the at the outer trailing edge and the leading outer edge of the ring itself, as shown. These tapers also assist with the easing in and out of the ring and may be tailored to match the desired force requirements.

It will be appreciated that the above-described device, retaining screw and circlip may be used in a number of applications both within and without of the human or animal body. Additionally, it will be appreciated that the screw itself and retaining circlip may be used as a retaining device in other articles requiring securing to another.

1. A retaining device, comprising a screw and a ring, said screw having a thread portion, a head portion and a shank portion of diameter D, said shank portion including a circumferentially extending groove in an outer diameter thereof for receiving said retaining ring, wherein said groove is spaced from said head portion and said ring comprising a split spring ring having a first compressed diameter (Dc) and a second expanded diameter (De) and wherein, in an expanded state, said ring includes a retaining portion for retention in said groove and a projecting portion for projecting beyond said groove and shank diameter D and for retaining said screw relative to an adjacent member.

2. A retaining device as claimed claim 1, wherein said ring has a radial depth Dr and said groove has a depth Dg within which at least a portion of the ring may be accommodated when said ring is at its compressed diameter (Dc).

3. A retaining device as claimed in claim 1, wherein said thread portion comprises a self tapping thread.

4. A retaining device as claimed in claim 1, wherein said retaining device includes a self drilling portion.

5. A retaining device as claimed in claim 1, and including a mounting member having a corresponding mounting aperture through which, in operation, said retaining device may be inserted, said mounting aperture having a diameter Dh larger than said shank diameter D but less than the expanded diameter De of said ring and having a length L equal to or less than the distance between the head and the groove portion.

6. A retaining device as claimed in claim 45, wherein said mounting member includes a complete circumferentially extending groove on an outer back surface for receiving said ring when said ring is in said expanded state.

7. A retaining device as claimed in claim 6 wherein said groove includes a tapered portion adjacent an outlet from said aperture.

8. A retaining device as claimed in 7 wherein said aperture includes a tapered inlet thereto.

9. A retaining device as claimed in claim 5, wherein said mounting member comprises an implant.

10. A retaining device as claimed in claim 5, wherein said mounting member comprises a prosthesis.

11. A retaining device as claimed in claim 5, wherein said mounting member comprises a cervical plate.

12. A retaining device as claimed in claim 5, wherein said mounting member comprises a vertebral cage.

13. A retaining device as claimed in any one of claims 5 to 12 wherein said mounting aperture includes a head receiving portion for receiving a head of a screw and further includes a tapered portion towards a base of said receiving portion for guiding said retaining ring as it is inserted.

14. A retaining device as claimed in claim 5 wherein said mounting aperture includes an exit portion into which the retaining device exits upon insertion and in which said exit portion includes a tapered portion tapering inwardly towards the base thereof so as to assist with the compression of the ring upon removal.

15. A retaining device as claimed in claim 5 wherein said ring includes a tapered portion on a trailing edge thereof.

16. (canceled)

17. A method of securing a mounting member having a hole of diameter Dh, said method comprising obtaining a retaining device comprising a screw and a ring, said screw having a thread portion, a head portion and a shank portion of diameter D, said shank portion including a circumferentially extending groove in an outer diameter thereof for receiving said retaining ring, wherein said groove is spaced from said head portion and said ring comprising a split spring ring having a first compressed diameter (Dc) and a second expanded diameter (De) and wherein, in an expanded state, said ring includes a retaining portion for retention in said groove and a projecting portion for projecting beyond said groove and shank diameter D and for retaining said screw relative to an adjacent member; wherein said shank diameter D is less than the hole diameter Dh, said ring expanded diameter De is greater than said hole diameter Dh, and said ring compressed diameter Dc is less than the diameter Dh of said hole;
said method including the steps of inserting said retaining device into said hole, causing said ring to be compressed to said compressed diameter Dc, passing said shank and ring through said hole and allowing said ring to expand to said expanded diameter De on an outlet side of said hole such as to cause said ring to resist said retaining device from being withdrawn back through said hole.

18. A method of securing into a structure of a subject a mounting member having a hole of diameter Dh, said method comprising obtaining a retaining device comprising a screw and a ring, said screw having a thread portion, a head portion and a shank portion of diameter D, said shank portion including a circumferentially extending groove in an outer diameter thereof for receiving said retaining ring, wherein said groove is spaced from said head portion and said ring comprising a split spring ring having a first compressed diameter (Dc) and a second expanded diameter (De); and
wherein, in an expanded state, said ring includes a retaining portion for retention in said groove and a projecting portion for projecting beyond said groove and shank diameter D and for retaining said screw relative to an adjacent member; wherein said shank diameter D is less than the hole diameter Dh, said ring expanded diameter De is greater than said hole diameter Dh, and said ring compressed diameter Dc is less than the diameter Dh of said hole; and
wherein said mounting hole includes an exit portion into which the retaining device exits upon insertion and in which said exit portion includes a tapered portion tapering inwardly towards the base thereof so as to assist with the compression of the ring upon removal;
said method further comprising inserting said mounting member into said hole and extending out said exit portion into said structure, causing said ring to be compressed to said compressed diameter Dc, passing said shank and ring through said hole and allowing said ring to expand to said expanded diameter De on an outlet side of said hole such as to cause said ring to resist said retaining device from being withdrawn back through said hole.

19. The method as claimed in claim 18, wherein said structure is a vertebral body.
